(19) United States
(12) Patent Application Publication
(10) Pub. No.: US 2007/0142100 A1
(43) Pub. Date: Jun. 21, 2007

(54) Speaker module for portable terminal

(75) Inventor: Kyung-Rok Lee, Hwaseong-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/641,133

(22) Filed: Dec. 19, 2006

(30) Foreign Application Priority Data
Dec. 19, 2005 (KR) 2005-0125120

(51) Int. Cl. H04M 1/00

(52) U.S. Cl. 455/575.3

(57) ABSTRACT

A speaker module for a portable terminal includes a speaker box having a predetermined size and receiving a speaker. The speaker box is installed at a predetermined location of a case frame of the portable terminal to protrude partially to the outside. The speaker box enters into the folder of the portable terminal while storing a predetermined elastic force. Because only the speaker module contacts a user's ear and elastically enters into the folder of the portable terminal, the stable sound quality is provided during voice communication, thereby securing the reliability of the portable terminal.

### PRIORITY

This application claims priority under 35 U.S.C. § 119 to an application entitled “Speaker Module For Portable Terminal” filed in the Korean Intellectual Property Office on Dec. 19, 2005 and assigned Serial No. 2005-125120, the contents of which are incorporated herein by reference.

### BACKGROUND OF THE INVENTION

1. Field of the Invention

The present invention relates generally to a speaker module for a portable terminal, and in particular, to a speaker module for a portable terminal, which can provide smooth voice communication by making a speaker part protrude and thus enabling close contact between the speaker part and a user's ear.

2. Description of the Related Art

In general, a portable terminal includes a keypad assembly and a display unit. The keypad assembly is a data input unit having a plurality of key buttons, and the display unit outputs data input by the data input unit or received data. Also, the portable terminal includes a microphone and a speaker for voice communication at predetermined locations.

In recent years, portable terminals are getting smaller, lighter and slimmer, with more various and complicated functions. Therefore, a microphone and a speaker also become so small that they are unnoticeable.

However, because the speaker installed as described above is generally fixed to a predetermined location of the portable terminal, contact between the portable terminal and users cannot be optimized according to various facial shapes of the users, thus degrading the voice communication quality and the reliability of the portable terminal.

### SUMMARY OF THE INVENTION

An object of the present invention is to substantially solve at least the above problems and/or disadvantages and to provide at least the advantages below. Accordingly, an object of the present invention is to provide a speaker module for a portable terminal, which can provide excellent communication quality by elastically protruding the speaker module corresponding to various facial curves of users and thus enabling close contact between the portable terminal and a users' ear.

Another object of the present invention is to provide a speaker module for a portable terminal, which is configured to improve the reliability of the portable terminal by providing excellent communication quality at all times.

A further object of the present invention is to provide a speaker module for a portable terminal, which can prevent the user from feeling unpleasant because of high-temperature heat generated from the portable terminal when the user uses the portable terminal for a long time.

According to an aspect of the present invention, a speaker module for a portable terminal includes a speaker box having a predetermined size and receiving a speaker, the speaker box being installed at a predetermined location of a case frame of the portable terminal to protrude partially to the outside. The speaker box enters into the folder of the portable terminal while storing a predetermined elastic force.

### BRIEF DESCRIPTION OF THE DRAWINGS

The above and other objects, features, and advantages of the present invention will become more apparent from the following detailed description when taken in conjunction with the accompanying drawings in which:

FIG. 1 is a perspective view of a portable terminal using a speaker module according to the present invention;

FIG. 2 is a schematic sectional view illustrating a relationship between an opening angle of the portable terminal and a protruding angle of the speaker module according to the present invention;

FIG. 3 is an exploded perspective view illustrating an installation state of the speaker module according to the present invention;

FIG. 4 is a rear perspective view of a speaker box according to the present invention;

FIG. 5 is a partial sectional view of the speaker module when it is installed at the portable terminal according to the present invention; and

FIGS. 6 and 7 are partial sectional views illustrating a mechanical operation of the speaker module according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail because they would obscure the present invention in unnecessary detail.

Although a rotatable speaker module installed in a folder of a folder type terminal is illustrated and described herein, the present invention is not limited thereto. The present invention can also be applied to various types of portable terminals, for example, bar type terminals, slide type terminals, and the like.

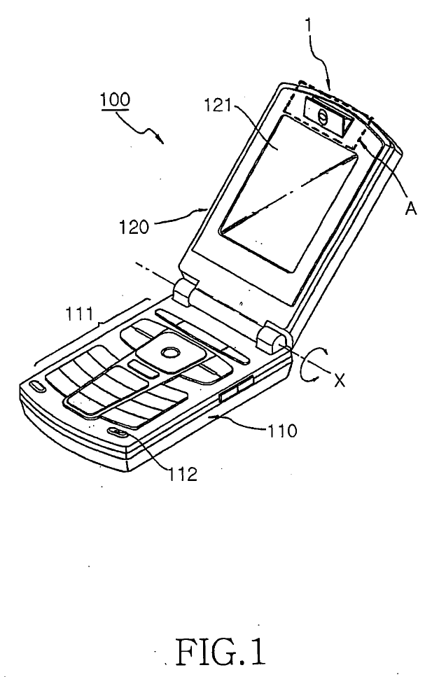

FIG. 1 is a perspective view of a portable terminal 100 using a speaker module 1 according to the present invention. The portable terminal 100 includes a main body 110, and a folder 120. The folder 120 is opened and closed with respect to the main body 110 at a predetermined angle around an X-axis. The main body 110 includes a keypad assembly 111 serving as a data input unit having a plurality of key buttons, and a microphone 112 disposed under the keypad assembly 111 to transmit a user's voice to another party. The folder 120 includes a display unit 121, and an earpiece (part A of FIG. 1) disposed above the display unit 121 to receive a voice of the other party. The earpiece is provided with a rotatable speaker module 1 according to the present invention. When a speaker box (10 of FIG. 3) opens the folder 120, the speaker module 1 rotates about one side at a predetermined angle and protrudes partially from an outer surface of the folder 120.

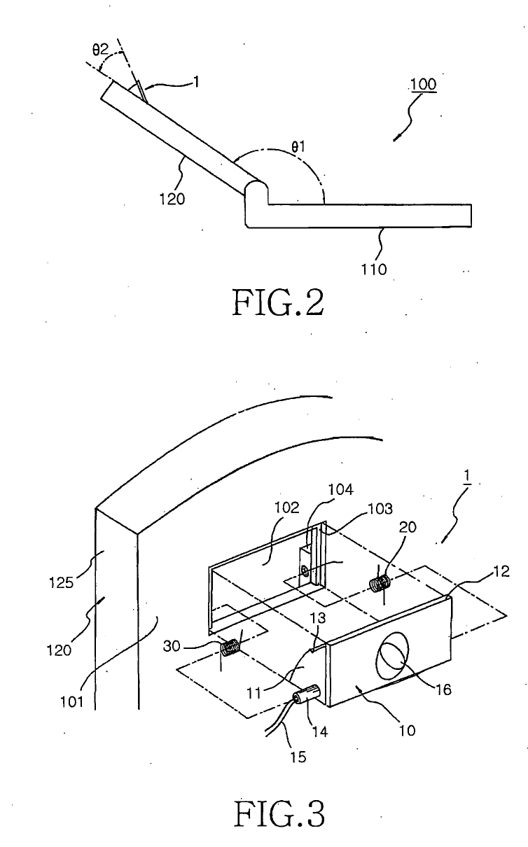

FIG. 2 is a schematic sectional view illustrating a relationship between an opening angle θ1 of the folder 120 of the portable terminal 100 and a protruding angle θ2 of the speaker module 1 according to the present invention. The portable terminal 100 is designed in consideration of the opening angle θ1 of the folder 120 and the protruding angle (32 of the speaker module 1. For example, if the speaker module 1 enters into the folder 120 by the half of the protruding angle θ2 due to the pressure with the user's ear for voice communication, the opening angle θ1 of the folder 120 would be set to θ1′ by adding an angle of θ2/2, where θ′ is an initial opening angle of the folder 120.

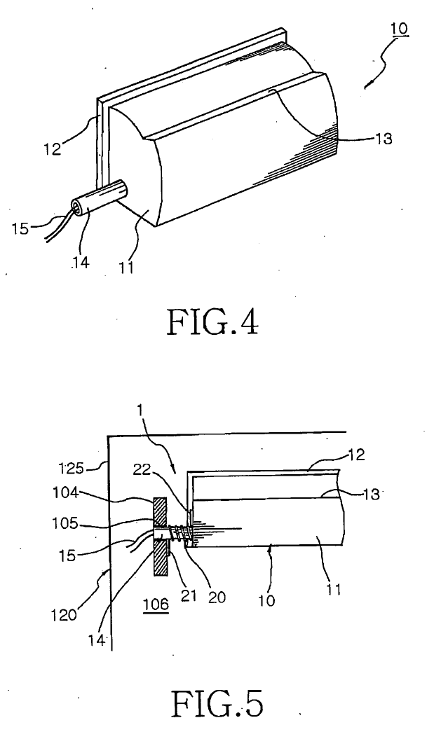

FIG. 3 is an exploded perspective view illustrating an installation state of the speaker module 1 according to the present invention, and FIG. 4 is a rear perspective view of the speaker box 10 according to the present invention.

As illustrated in FIGS. 3 and 4, the speaker module 1 includes a speaker box 10 accommodating a speaker (not shown) and movably installed at a case frame 125 of the folder 120. More specifically, the speaker box 10 is installed to protrude partially from an outer surface 101 of the case frame 125.

The speaker box 10 includes a rear housing 11 having a predetermined receiving part, and a front panel 12 formed integrally with the rear housing 11. The rear housing 11 is received in the folder 120 and protrudes partially to the outside of the folder 120. The front panel 12 protrudes from an outer surface of the folder 120 to contact the user's ear, and includes a speaker hole 16 for transmitting a sound output from the speaker to the user.

A shaft 14 of a predetermined length protrudes at both sides of the rear housing 11. The shaft 14 is rotatably inserted into a through hole 105 of a bushing 104 protrudingly installed at an inner surface (106 of FIG. 5) of a terminal case frame 125. The shaft 14 is hollow, and a hollow part thereof communicates with the speaker receiving part of the rear housing 11, and serves as a path through which a connection unit 15 electrically connected to the speaker in the rear housing 11 is led out. A fine cable, a flexible printed circuit (FPC), or the like may be used as the electrical connection unit 15. The electrical connection unit 15 led out through the shaft 14 may be connected onto a slave PCB (not shown) of the folder 120.

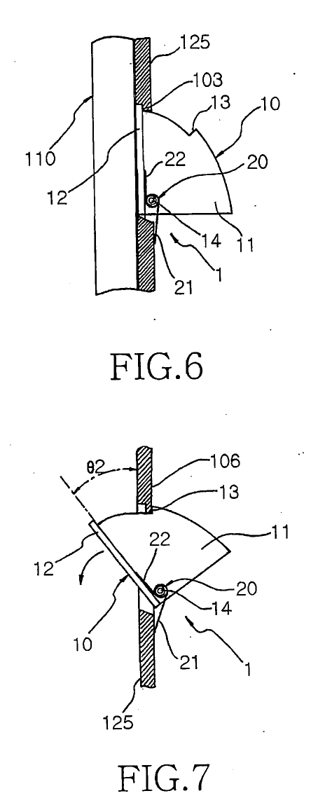

The front panel 12 has a flange at its edge which has an area greater than the rear housing 11. so that the front panel 12 is mounted to a recess 103 around the aperture 102 to receive the speaker box 10 in the case frame 125. Accordingly, when the speaker box 10 completely enters into the aperture 102 while storing an elastic force from an elastic unit, which will be described later, the front panel 12 of the speaker box 10 is fitted into an outer surface 101 of the case frame 125 of the folder 120. Thus, as in the case of FIG. 6, when the folder 120 is folded with the main body 110, there is no space between the main body 110 and the folder 120, thus making the portable terminal look elegant.

Furthermore, the speaker box 10 includes a movement limiting unit. The movement limiting unit makes the speaker box 10 protrude partially from the folder 120, but preventing its complete separation therefrom. A protruding stepped portion 13 is formed at an outer surface of the rear housing 11 and is caught by the inner surface 106 of the folder case frame 125. Preferably, the rear housing 11 having the stepped portion 13, the shaft 14, and the front panel 12 may be integrally formed by plastic injection molding.

In the absence of an external force, the speaker box 10 is pressed by an elastic unit to protrude outward from the folder 120 at a given angle. Torsion springs 20 and 30 may serve as the elastic unit, but the present invention is not limited thereto. Any well-known elastic units may be used if only they can exert a force on the speaker box 10 in an outward direction of the folder 120 to rotate the speaker box 10 about the shaft 14 of the speaker box 10.

FIG. 5 is a partial sectional view of the speaker module 1 when it is installed at the portable terminal according to the present invention. Specifically, the speaker module 1 viewed from an inner surface of the folder case frame 125 is illustrated in FIG. 5.

As illustrated in FIG. 5, the shaft 14 protruding at the speaker box 10 penetrates the through hole 105 of the bushing 104 formed at the inner surface 106 of the case frame 125. The torsion spring 20 is installed at the shaft 14 in a manner that the shaft 14 penetrates there through. The torsion spring 20 is installed with a clearance large enough to allow an idle rotation of the shaft 14. A central circular portion of the torsion spring 20 has a diameter greater than an outer diameter of the shaft 14. One end 21 of the torsion spring 20 is supported by the inner surface 106 of the case frame 125 of the folder 120, and the other end 22 thereof is installed to press against the flange portion of the speaker box 10. Even though only one side of an installation structure of the speaker box 10 is illustrated, the other side may also be configured in the same manner as the illustrated one. The torsion spring 20 is supported by the inner surface 106 of the case frame 125 to press against the speaker box 10 in an outward direction of the folder 120.

FIGS. 6 and 7 are partial sectional views illustrating a mechanical operation of the speaker module according to the present invention. Specifically, FIG. 6 is a partial sectional view of the folder 120 when it is folded with the main body 110.

As illustrated in FIG. 6, when the folder 120 is folded with the main body 110, the speaker box 10 is kept in the case frame 125. The speaker box 10 is pushed by a contact surface of the main body 110 where the contact with the folder 120 is made, and thus is rotated into the folder 120 about the shaft 14. Here, the speaker box 10 stores a force to protrude outward from the folder 120 by the force exerted from the torsion spring 20.

FIG. 7 is a partial sectional view of the folder 120 when it is opened from the main body 110 at a predetermined angle. When the contact surface of the main body 110 is distanced from the folder 120, the speaker box 10 is rotated about the shaft 14 and thus protrudes partially to the outside. This occurs by an elastic force of the torsion spring 20. The angle at which the speaker box 10 protrudes is limited to θ2 by the stepped portion 13 formed at a predetermined location of the rear housing 11 as a movement limiting unit. That is, the stepped portion 13 is caught by the inner surface 106 of the folder case frame 125, so that excessive protrusion and complete separation of the speaker box 10 can be prevented.

Accordingly, to make voice communication using the portable terminal 100, the user opens the folder 120 and attaches the front panel 12 of the protruding speaker box 10 to the user's ear. Because the speaker box 10 elastically enters into the folder 120 depending on a facial shape of the user, close contact between the speaker box 10 and the user's ear is made. Thus, a sound is transmitted to the user at constant volume, and the user does not feel unpleasant because no heat is transmitted to the user from the portable terminal.

Although not shown in the drawing, the present invention can be applied to a terminal having an earpiece exposed all the time, such as a bar type terminal, a slide type terminal, and the like. In this case, the speaker box may be installed to protrude by a user's selection. Also, a locking unit for keeping the speaker box in the portable terminal, and a release button for releasing the speaker box may be additionally provided.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A speaker module for a portable terminal having a main body and a folder, comprising:
a speaker box having a predetermined size and receiving a speaker, the speaker box being installed at a predetermined location of a case frame of the folder of the portable terminal to protrude partially to the outside of the folder,
wherein the speaker box enters into the folder of the portable terminal while storing a predetermined elastic force.

2. The speaker module of claim 1, wherein the speaker box rotates to protrude partially from a predetermined-shaped aperture formed at the case frame of the folder.

3. The speaker module of claim 2, wherein the speaker box comprises:
a front panel including a speaker hole;
a rear housing having a predetermined shape and receiving the speaker, the rear housing being integrally formed with the front panel;
a hollow shaft protruding at predetermined locations of both sides of the rear housing and rotatably mounted to an inner surface of the folder; and
a movement limiting unit limiting the speaker box such that the speaker box protrudes from the folder.

4. The speaker module of claim 3, wherein the aperture of the case frame of the folder includes a pair of bushings at a predetermined location, each of the bushings having a through hole through which the hollow shaft penetrates to rotate the speaker box.

5. The speaker module of claim 4, further comprising an elastic unit installed between the speaker box and the bushing and exerting a force on the speaker box in an outward direction of the folder until a movement of the speaker box is limited by the movement limiting unit.

6. The speaker module of claim 3, wherein a hollow potion of the shaft serves as a path through which an electrical connection unit connected to the speaker in the rear housing is led out.

7. The speaker module of claim 3, wherein the front panel includes a flange at an edge of the front panel around the rear housing, and the aperture of the case frame of the folder includes a recess around the aperture, so that the flange is received in the recess.

8. The speaker module of claim 7, wherein when the flange of the front panel is received in the recess, an outer surface of the front panel is fitted into an outer surface of the case frame of the folder.

9. The speaker module of claim 3, wherein the movement limiting unit is a stepped portion protrudingly installed at an outer surface of the rear housing, so that when rotated at a predetermined angle, the speaker box is caught by an inner surface of the case frame of the folder.

10. The speaker module of claim 5, wherein the elastic unit is a torsion spring having one end supporting an inner surface of the case frame of the folder and the other end exerting a force on the speaker box in an outward direction of the folder.

11. The speaker module of claim 10, wherein the torsion spring is mounted around the shaft to allow an idle rotation of the shaft.

12. A portable terminal, comprising:
a first body;
a second body which is connected to the first body; and a speaker module comprising, a speaker; and a speaker box in which the speaker is included, the speaker box being installed at a location of a case frame of the second body of the portable terminal to protrude partially to the outside of the second body, wherein the speaker box enters into the second body of the portable terminal while storing a predetermined elastic force.

13. The portable terminal of claim 12, wherein the speaker box rotates to protrude partially from a predetermined-shaped aperture formed at the case frame of the second body.

14. The portable terminal of claim 13, wherein the speaker box comprises:
a front panel including a speaker hole;
a rear housing having a predetermined shape and receiving the speaker, the rear housing being integrally formed with the front panel;
a hollow shaft protruding at predetermined locations of both sides of the rear housing and rotatably mounted to an inner surface of the second body; and
a movement limiting unit limiting the speaker box such that the speaker box protrudes from the second body.

15. The portable terminal of claim 14, wherein the aperture of the case frame of the second body includes a pair of bushings at a predetermined location, each of the bushings having a through hole through which the hollow shaft penetrates to rotate the speaker box.

16. The portable terminal of claim 15, further comprising an elastic unit installed between the speaker box and the bushing and exerting a force on the speaker box in an outward direction of the second body until a movement of the speaker box is limited by the movement limiting unit.

17. The portable terminal of claim 14, wherein a hollow potion of the shaft serves as a path through which an electrical connection unit connected to the speaker in the rear housing is led out.

18. A portable terminal, comprising:
a body; and a speaker module included in the main body, comprising, a speaker; and a speaker box in which the speaker is included, the speaker box being installed at a location of a case frame of the body of the portable terminal to protrude partially to the outside of the body, wherein the speaker box enters into the body of the portable terminal while storing a predetermined elastic force.

19. The portable terminal of claim 18, wherein the speaker box rotates to protrude partially from a predetermined-shaped aperture formed at the case frame of the body.

20. The portable terminal of claim 19, wherein the speaker box comprises:
a front panel including a speaker hole;
a rear housing having a predetermined shape and receiving the speaker, the rear housing being integrally formed with the front panel;
a hollow shaft protruding at predetermined locations of both sides of the rear housing and rotatably mounted to an inner surface of the body; and
a movement limiting unit limiting the speaker box such that the speaker box protrudes from the body.
